(19) United States
(12) Patent Application Publication
(10) Pub. No.: US 2006/0268562 A1
(43) Pub. Date: Nov. 30, 2006

(54) Illuminated brake caliper faceplate for motor vehicles

(76) Inventor: Samuel M. Smith II, Bend, OR (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/434,708

(22) Filed: May 16, 2006

Related U.S. Application Data
(60) Provisional application No. 60/684,087, filed on May 24, 2005.

(51) Int. Cl. B60Q 1/26

(52) U.S. Cl. 362/500

(57) ABSTRACT

A motor vehicle brake caliper and surrounding area of the vehicle are illuminated by a system that includes a caliper-shaped frame and illumination system. The frame retains one or more illumination elements, such as electroluminescent wire that emits a neon-like glow.

### CROSS-REFERENCE TO RELATED APPLICATION

The benefit of the filing date of U.S. Provisional Patent Application Ser. No. 60/684,087, filed May 24, 2005, entitled “ILLUMINATED BRAKE CALIPER FACEPLATE FOR MOTOR VEHICLES,” is hereby claimed, and the specification thereof incorporated herein in its entirety by this reference.

### BACKGROUND OF THE INVENTION

1. Field of the Invention

The present invention relates generally to motor vehicle equipment and, more specifically, to a cover or faceplate for brake calipers.

2. Description of the Related Art

Automobile enthusiasts have been known to customize their vehicles with various ornamental or esthetic features. For example, aftermarket kits are available to provide a neon-like glow effect that illuminates the automobile underbody.

Automobile wheels having relatively large openings or areas between the spokes are popular, especially on sportier models. Elements of the brake system, such as the rotor and caliper, are often visible through these open areas. Some may find the rotors themselves esthetically pleasing, as they are typically shiny from the polishing effect of the caliper during braking and may have interesting perforations or apertures intended to enhance heat dissipation. In sports cars and cars customized for performance or a performance look, the caliper may be treated to enhance its appearance against the rotor. For example, calipers painted red or another eye-catching color are known. Along the same lines, aftermarket caliper covers are available that can be attached to the caliper. An example is disclosed in U.S. Design Pat. No. D476,275.

Devices that illuminate portions of automobile wheels are known. For example, U.S. Pat. No. 6,612,726 discloses a device having an array of light-emitting diodes (LEDs) mounted to a bracket that is extended off the side of the brake caliper. The LEDs are connected to a battery power source that can be either part of the vehicle or standalone. The lights are controlled through a microprocessor and are triggered as to provide a strobe effect when the vehicle is moving. U.S. Pat. No. 5,530,630 discloses an apparatus for lighting a wheel using a rotating commutator and brush to conduct electricity to a light mounted on a fixture that rotates with the wheel.

The above-described illumination devices do not directly relate to the brakes. It would be desirable to provide an illumination device that is integrated with and complements brake calipers. The present invention addresses these problems and deficiencies and others in the manner described below.

### SUMMARY OF THE INVENTION

The present invention relates to an illumination apparatus and illumination method for the visible (housing) portion of a motor vehicle brake caliper assembly. The apparatus includes an illumination system that provides a lighting effect on or around the caliper housing surface and a frame that retains one or more of the illumination elements of the illumination system. In an exemplary embodiment of the invention, a cover-like or faceplate-like device can be retrofitted to an existing caliper without removing the caliper from the vehicle. In other embodiments, the illumination system can be more permanently mounted to the caliper or even integrally manufactured with the caliper assembly housing. Nevertheless, the illumination system can be mounted on the caliper assembly in any other suitable manner that provides a lighting effect on portions of the caliper assembly or surrounding elements.

In the exemplary embodiment, the device has a caliper-shaped (i.e., arcuate, bow-shaped, curved, kidney-shaped, etc.) frame, as such a shape corresponds generally to the shape of the motor vehicle brake caliper assembly housing on which it is mounted. The illumination system can comprise, for example, electroluminescent (EL) wire arranged in a pattern on the front surface or faceplate of the frame. The pattern can follow the outline of the faceplate so as to convey or emphasize the caliper shape to an observer. The illumination system can be connected to a suitable power source, such as the vehicle's brake light circuit or running light circuit. In this manner, the system provides an esthetically pleasing appearance as well as other advantages, including additional safety illumination.

### BRIEF DESCRIPTION OF THE DRAWINGS

FIG. 1 is a perspective view illustrating a brake caliper illumination apparatus installed in an automobile in accordance with an exemplary embodiment of the invention.

FIG. 2 is a perspective view illustrating the installation of the apparatus of FIG. 1.

FIG. 3 is a top elevational view of the apparatus frame in the exemplary embodiment.

FIG. 4 is an exemplary wiring diagram for the illumination system of the apparatus.

### DETAILED DESCRIPTION

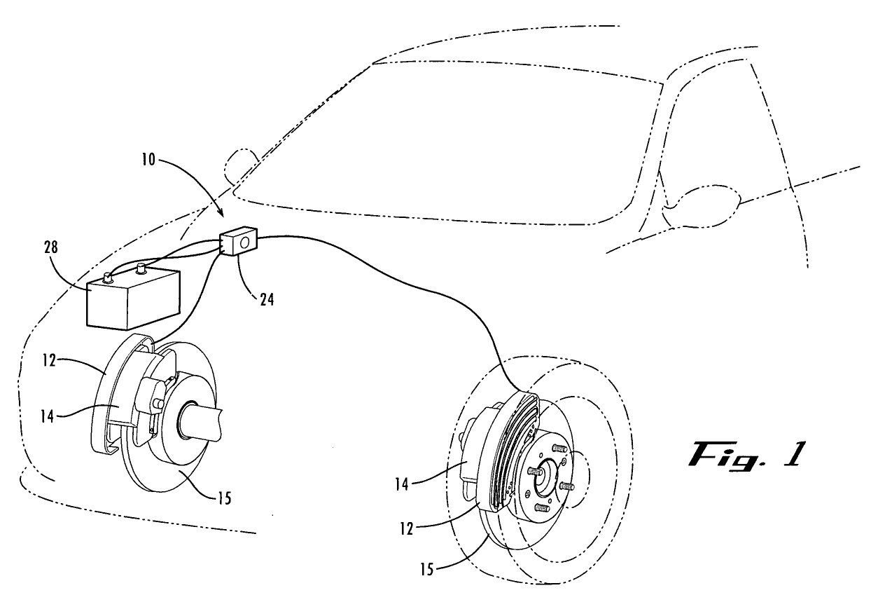

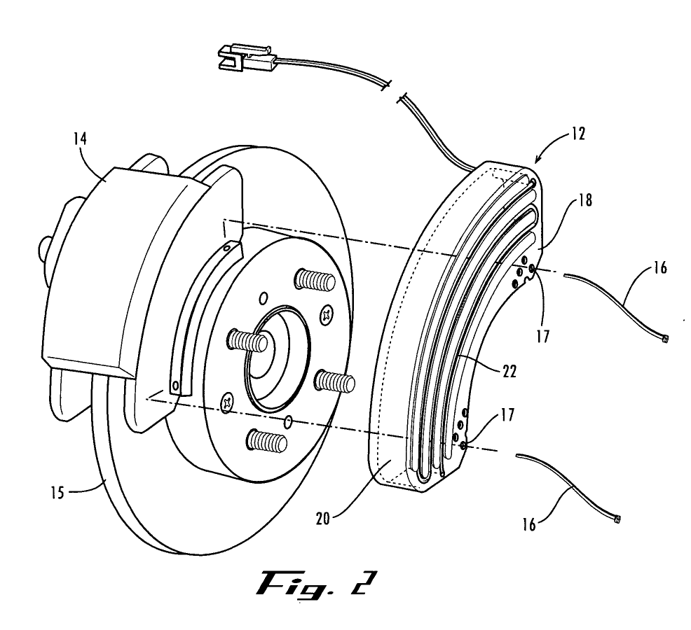

As illustrated in FIG. 1, a brake caliper illumination apparatus is installed in an automobile (indicated in dashed line). The apparatus includes an illumination system 10 and one or more frames 12. As illustrated in further detail in FIG. 2, a frame 12 is mounted on or over each of the automobile's front brake caliper assembly housings (referred to herein simply as brake calipers 14 for purposes of convenience). Although the brake rotor assemblies 15 are shown for reference purposes, they are not relevant to the invention except to the extent that the illumination described below may impinge upon them as part of the overall illumination effect. In the exemplary embodiment of the invention, zip-ties 16 (also known as cable ties) are conveniently used to mount frame 12 by looping them through holes 17 in frame 12 and other holes in caliper 14 and zipping them closed, but in other embodiments any other suitable mounting means can be used. Note that one can conveniently mount frame 12 in this manner without removing caliper 14 from the automobile.

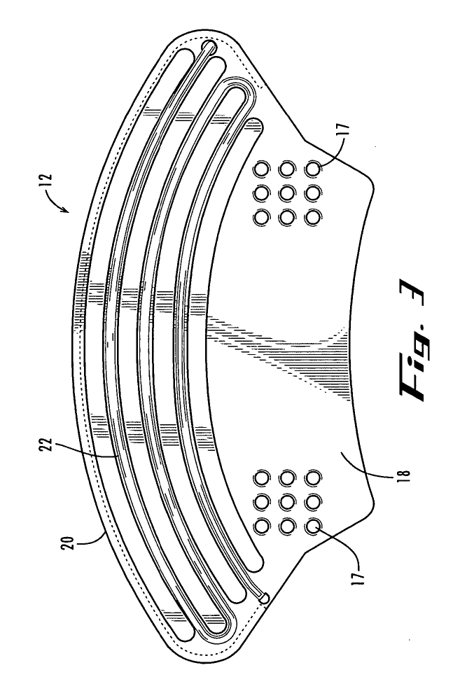

As further illustrated in FIG. 3, frame 12 has a shape and size that correspond generally to the shape and size of caliper 14. Thus, as brake calipers are generally known to have a substantially arcuate shape, frame 12 correspondingly has a substantially arcuate shape. In the exemplary embodiment of the invention, frame 12 fits over or on caliper 14 and thus has a size or profile slightly larger than the profile of caliper 14. In other embodiments, the frame can be slightly smaller than caliper 14 or deviate to a slightly greater extent from the shape of caliper 14. As described below, such arrangements facilitate retention of illumination elements or portions thereof substantially within the periphery of caliper 14.

Frame 12 comprises a faceplate 18 unitarily formed with a skirt or rim 20. The two elements may be unitarily formed in any suitable manner, such as by plastic injection molding a unitary part, frame 12. Nevertheless, in other embodiments of the invention they can be separately joined elements, and in still other embodiments rim 20 can be omitted altogether. Faceplate 18 has the arcuate shape that corresponds to that of the brake caliper 14 on which it is mounted. Rim 20 extends perpendicularly to faceplate 18 in a skirt-like manner and follows the arcuate shape of faceplate 18 around the upper edge of faceplate 18 and curves around the ends of faceplate 18. Although in the illustrated embodiment faceplate 18 has a substantially planar shape with no openings or voids except holes 17, in other embodiments it can have any other suitable shape and structure that can retain suitable illumination elements. Frame 12 can be made of molded plastic having a bright, eye-catching color, such as bright red, yellow or blue, to enhance its visibility during daytime.

An electroluminescent (EL) wire 22 is seated in a groove molded into faceplate 18. EL wire 22 is in itself well-known in the art and commercially available from a variety of sources. As known in the art, when energized with electric current, EL wire 22 emits a glowing light that resembles that of a neon tube lamp. For that reason, it is sometimes also referred to as neon wire. EL wire 22 is available in a variety of colors, and any suitable color can be used. The color can match that of frame 12 or contrast with it. Note that although in the exemplary embodiment of the invention the illumination element comprises EL wire 22, in other embodiments any other suitable illumination elements, such as light-emitting diodes, can be used. The term “illumination element” can include not only individual sources of light, as in the exemplary embodiment, but also a module or assembly comprising a plurality of light sources. In addition, such other embodiments can include any suitable lenses, diffusers, masks or other elements (not shown) in the illumination path to provide interesting lighting effects.

EL wire 22 follows the arcuate shape of faceplate 18 and loops back and forth from one end of faceplate 18 to the other three times in the illustrated embodiment, resulting in a pattern that resembles three arcs. In nighttime, when frame 12 may be difficult to discern, an observer may essentially see only three illuminated arcs where they are aware caliper 14 is located plus some portion of other elements (e.g., caliper 14, rotor 15 and the wheels) on which some of the illumination may impinge. Such a pattern that substantially corresponds to the shape of caliper 14 and is disposed substantially within the periphery of caliper 14 may be advantageous because it conveys to the observer that the illumination distinctly emanates from and is associated with caliper 14. Nevertheless, in other embodiments the EL wire or other illumination element or elements can be retained in frame 12 in any suitable pattern (or in no pattern).

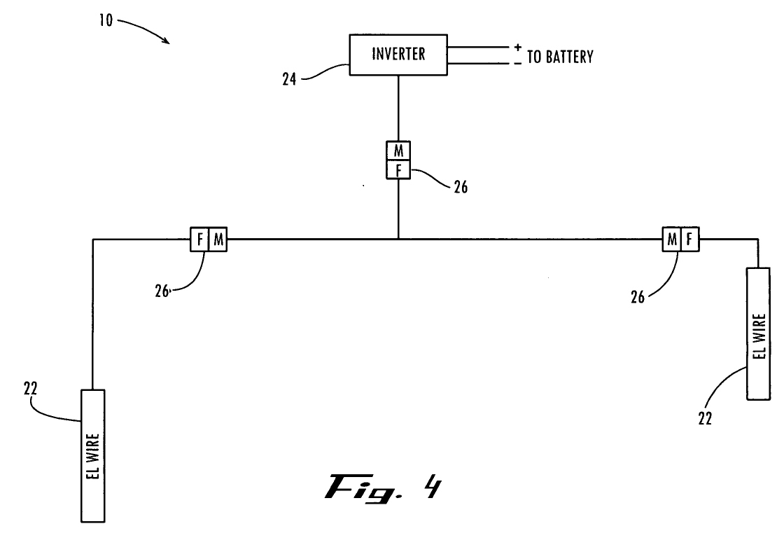

As illustrated in FIG. 4, in the exemplary embodiment of the invention illumination system 10 comprises EL wires 22, a power inverter 24, a number of connectors 26 (each comprising a mating plug or male (“M”) connector and jack or female (“F”) connector), and wires or leads interconnecting these components. Connectors 26 can be of any suitable type, such as those commonly used in automotive wiring harnesses. In installing the apparatus in a vehicle, the leads can be routed in an unobtrusive manner between the brakes and inverter 24, which can be mounted in the engine compartment or other suitable location. Inverter 24 is connected to the automobile's battery 28 (FIG. 1) or other power source, either directly or via a suitable automobile power circuit. For example, inverter 24 can be connected in the automobile brake light circuit, so that when the brake lights are activated (by the driver pressing on the brake pedal) illumination system 10 is also activated. Similarly, inverter 24 can be connected in the automobile running light circuit, so that when the running lights are activated (by the driver turning on the headlights or the running lights), illumination system 10 is also activated. Inverter 24 can alternatively be connected to a dedicated circuit that a user can activate using a switch (not shown) that can be installed in the vehicle dashboard. In other embodiments, additional electronics can be included to cause the illumination elements to flash or behave in some other manner.

When illumination system 10 is activated, EL wire 22 emits a neon-like glow that conveys the caliper shape as described above and also illuminates portions of adjacent elements, such as faceplate 18, caliper 14, rotor 15, and the wheels.

It is to be understood that the present invention is not limited to the specific devices, methods, conditions, or parameters described and/or shown herein, and that the terminology used herein is for the purpose of describing particular embodiments of the invention by way of example only. For example, unless the context clearly dictates otherwise, as used in the specification and the appended claims, a reference to an element using the singular article “a,” “an,” or “the” encompasses both embodiments having no more than one and embodiments having more than one. The term “or” means “either or both.” Likewise, a reference to an element “on” another element also encompasses embodiments in which one is “in” the other, and conversely, a reference to an element “in” another element also encompasses embodiments in which one is “on” the other. “Coupled” means connected via zero or more intermediate elements. Also, a reference to a particular numerical value includes at least that particular value. In addition, any methods or processes set forth herein are not intended to be limited to the sequence of steps set forth but also encompass other sequences, unless expressly stated otherwise. With regard to the claims, no claim is intended to invoke the sixth paragraph of 35 U.S.C. Section 112 unless it includes the term “means for” followed by a participle.

It will be apparent to those skilled in the art that various modifications and variations can be made to this invention without departing from the spirit or scope of the invention. Thus, it is intended that the present invention cover all modifications and variations of this invention that come within the scope of one or more claims and their equivalents.

What is claimed is:

1. A brake caliper illumination apparatus, comprising:
a caliper-shaped frame having a substantially arcuate shape corresponding generally in shape and size to a motor vehicle brake caliper assembly housing; and
an illumination system comprising at least one illumination element retained in the frame.

2. The brake caliper illumination apparatus claimed in claim 1, wherein the frame comprises:
a faceplate having the substantially arcuate shape; and
a rim having the substantially arcuate shape and extending perpendicularly from an edge of the faceplate along at least a portion of the edge.

3. The brake caliper illumination apparatus claimed in claim 1, wherein the illumination element is elongated and wire-like.

4. The brake caliper illumination apparatus claimed in claim 3, wherein the illumination element comprises electroluminescent (EL) wire.

5. The brake caliper illumination apparatus claimed in claim 4, wherein the EL wire is seated in a groove in a portion of the frame.

6. The brake caliper illumination apparatus claimed in claim 1, wherein the cover is made of a brightly colored molded plastic to promote daytime visibility.

7. The brake caliper illumination apparatus claimed in claim 1, wherein the illumination system is distributed over a portion of the frame in a pattern that substantially corresponds to at least a portion of the shape of the caliper, whereby the pattern conveys the caliper shape.

8. The brake caliper illumination apparatus claimed in claim 7, wherein the illumination element comprises a wire-like illumination element disposed in a pattern that follows at least a portion of the arcuate shape of the frame.

9. The brake caliper illumination apparatus claimed in claim 8, wherein the illumination element comprises electroluminescent (EL) wire.

10. A method for providing brake caliper illumination, comprising:
mounting an illumination apparatus on a surface of a motor vehicle brake caliper, the illumination apparatus including at least a portion of an illumination element disposed substantially within a periphery of the brake caliper.

11. The method claimed in claim 10, wherein the step of mounting an illumination apparatus comprises mounting a frame on a brake caliper, the frame having a substantially arcuate shape corresponding generally in shape and size to a motor vehicle brake caliper assembly housing, and wherein the illumination element is retained in the frame.

12. The method claimed in claim 11, wherein the frame comprises:
a faceplate having the substantially arcuate shape; and
a rim having the substantially arcuate shape and extending perpendicularly from an edge of the faceplate along at least a portion of the edge.

13. The method claimed in claim 10, wherein the illumination element comprises a wire-like illumination element.

14. The method claimed in claim 13, wherein the illumination element comprises electroluminescent (EL) wire.

15. The method claimed in claim 14, wherein the EL wire is seated in a groove in a portion of the frame.

16. The method claimed in claim 11, wherein the frame is made of a brightly colored molded plastic to promote daytime visibility.

17. The method claimed in claim 11, wherein the illumination element is distributed over a portion of the frame in a pattern that substantially corresponds to at least a portion of the shape of the caliper, whereby the pattern conveys the caliper shape.

18. The method claimed in claim 17, wherein the illumination element is elongated and wire-like and is disposed in a pattern that follows at least a portion of the arcuate shape of the frame.

19. The method claimed in claim 18, wherein the illumination element comprises electroluminescent (EL) wire.

20. The method claimed in claim 11, wherein the mounting step comprises securing the frame to the caliper with zip-ties.

21. The method claimed in claim 10, further comprising electrically connecting the illumination apparatus to a brake light circuit of a motor vehicle.

22. The method claimed in claim 10, further comprising electrically connecting the illumination apparatus to a running light circuit of a motor vehicle.
